(19) United States
(12) Patent Application Publication
(10) Pub. No.: US 2026/0351865 A1
(43) Pub. Date: Nov. 5, 2026

(54) TERMINAL INSULATION PIERCING CONNECTOR

(71) Applicant: Hubbell Incorporated, Shelton, CT (US)

(72) Inventor: Richard E. Robicheau, Litchfield, NH (US)

(21) Appl. No.: 19/665,512

(22) Filed: May 1, 2026

Related U.S. Application Data
(60) Provisional application No. 63/798,741, filed on May 2, 2025.

(51) Int. Cl. H01R 4/2407; H01R 4/2408; H01R 11/12; H01R 43/01

(52) U.S. Cl. CPC H01R 4/2407; H01R 4/2408; H01R 11/12; H01R 43/01

(57) ABSTRACT

A terminal connector includes a base, a connector portion that extends from the base, and a tooth. The connector portion includes a first passage and the tooth is disposed at least partially along the first passage. The first passage can receive an unstripped portion of an electrical conductor. The tooth can pierce the unstripped portion and form an electrical connection between the connector portion and the electrical conductor.

### CROSS-REFERENCE TO RELATED APPLICATION

This claims the benefit of U.S. Provisional Application No. 63/798,741, filed May 2, 2025, the contents of which is incorporated by reference herein in its entirety.

### FIELD

The present disclosure relates to a wire terminal. More particularly, the present disclosure relates to a wire terminal for piercing an insulated conductor.

### BACKGROUND

A terminal connector may be used to receive an end of an electrical conductor. The terminal connector may be constructed at least partially from an electrically conductive material (e.g., metal). Before connecting the electrical conductor to the terminal connector, a technician may strip a portion of an insulative casing from the electrical conductor so that the exposed wire is received within the terminal connector. The process of stripping the wire may be time consuming and inefficient for a technician.

### SUMMARY

Various examples of the present disclosure can overcome various of the aforementioned and other disadvantages associated with known terminal connectors and offer new advantages as well.

In some forms, there is provided a terminal connector with a channel with at least one tooth disposed in the channel.

In some forms, there is provided a terminal connector that includes a base, a connector portion that extends from the base, and a tooth. The connector portion includes a first passage and the tooth is disposed at least partially along the first passage.

In some forms, there is provided a terminal connector with a connector portion that includes a first passage and a tooth removably coupled to a surface of the first passage. The first passage can receive an unstripped portion of an electrical conductor. The tooth can pierce the unstripped portion and form an electrical connection between the connector portion and the electrical conductor.

In some forms, there is a terminal connector that includes a base with a bend, a connector portion that extends from the base, and a tooth. The bend disposes the connector portion and at least a portion of the base on different planes. The connector portion includes a first passage and a second passage that intersects the first passage. The tooth is disposed at least partially along the first passage and is formed from an electrically conductive material. The first passage can receive an unstripped portion of an electrical conductor. The tooth can pierce the unstripped portion and form an electrical connection between the connector portion and the electrical conductor. The bend can permit the base to be fastened on a first surface and receive the electrical conductor that extends from a different plane than the first surface.

In some forms, there is a terminal connector that includes a base and a pair of connector portions that extend from the base. Each connector portion includes a respective first passage and a respective second passage that intersects the respective first passage. A respective tooth is disposed at least partially along each respective first passage. Each respective tooth is formed from an electrically conductive material. Each respective first passage can receive an unstripped portion of a respective electrical conductor. Each respective tooth can pierce the unstripped portion of the respective electrical conductor and form an electrical connection between the respective connector portion and the respective electrical conductor.

In some forms, there is provided a method of connecting an electrical conductor to a terminal. The method includes aligning an electrical conductor having an insulative cover with a channel of the terminal, and inserting the electrical conductor into the channel to contact one or more teeth. The teeth can at least partially strip the insulative cover to form an electrical connection between the terminal and the electrical conductor.

In some forms, there is provided a method of electrically connecting an electrical conductor to a terminal connector. The electrical conductor is inserted into a first passage of the terminal connector. The electrical conductor includes an insulating portion covering a conductive portion. An insulator portion is pierced with a tooth disposed in the first passage to expose the conductive portion. A fastener is moved through a second passage oriented perpendicular to the first passage to secure the electrical conductor within the first passage.

In some forms, there is a method of assembling a terminal connector for use with an electrical conductor. A connector portion is provided that includes a first passage. A tooth is selectively coupled to a surface of the first passage based on a status of the electrical conductor. The tooth is formed from an electrically conductive material. When the electrical conductor is unstripped, the tooth is coupled to the surface of the first passage to pierce an insulating portion of the electrical conductor and form an electrical connection between the connector portion and the electrical conductor. When the electrical conductor is stripped, the tooth is omitted from the first passage.

The disclosure herein should become evident to a person of ordinary skill in the art given the following enabling description and drawings. The drawings are for illustration purposes only and are not drawn to scale unless otherwise indicated. The drawings are not intended to limit the scope of the disclosure. The following enabling disclosure is directed to one of ordinary skill in the art and presupposes that those aspects within the ability of the ordinarily skilled artisan are understood and appreciated.

### BRIEF DESCRIPTION OF THE DRAWINGS

Various aspects and advantageous features of the present disclosure will become more apparent to those of ordinary skill when described in the detailed description of preferred examples and reference to the accompanying drawing wherein:

FIG. 1 is a perspective view of a first wire terminal.

FIG. 2 is a side view of the first wire terminal of FIG. 1.

FIG. 3 is a front view of the first wire terminal of FIG. 1.

FIG. 4 is a perspective view of a second wire terminal.

FIG. 5 is a top view of the second wire terminal of FIG. 4.

FIG. 6 is a side view of the second wire terminal of FIG. 4.

FIG. 7 is a perspective view of a third wire terminal.

FIG. 8 is a top view of the third wire terminal of FIG. 7.

FIG. 9 is a side view of the third wire terminal of FIG. 7.

FIG. 10 is a top view of an alternate example of the third wire terminal.

FIG. 11 is a side view of the alternate example of the third wire terminal of FIG. 10.

FIG. 12 is a perspective view of a fourth wire terminal.

FIG. 13 is a top view of the fourth wire terminal of FIG. 12.

FIG. 14 is a side view of the fourth wire terminal of FIG. 12.

FIG. 15 is a perspective view of a fifth wire terminal.

FIG. 16 is a side view of the fifth wire terminal of FIG. 15.

FIG. 17 is a top view of the fifth wire terminal of FIG. 15.

FIG. 18 is a perspective view of a sixth wire terminal.

FIG. 19 is a top view of the sixth wire terminal of FIG. 18.

FIG. 20 is a side view of the sixth wire terminal of FIG. 18.

FIG. 21 is a perspective view of a seventh wire terminal.

FIG. 22 is a top view of the seventh wire terminal of FIG. 21.

FIG. 23 is a side view of the seventh wire terminal of FIG. 21.

FIG. 24 is a perspective view of an eighth wire terminal.

FIG. 25 is a top view of the eighth wire terminal of FIG. 24.

FIG. 26 is a side view of the eighth wire terminal of FIG. 24.

### DETAILED DESCRIPTION

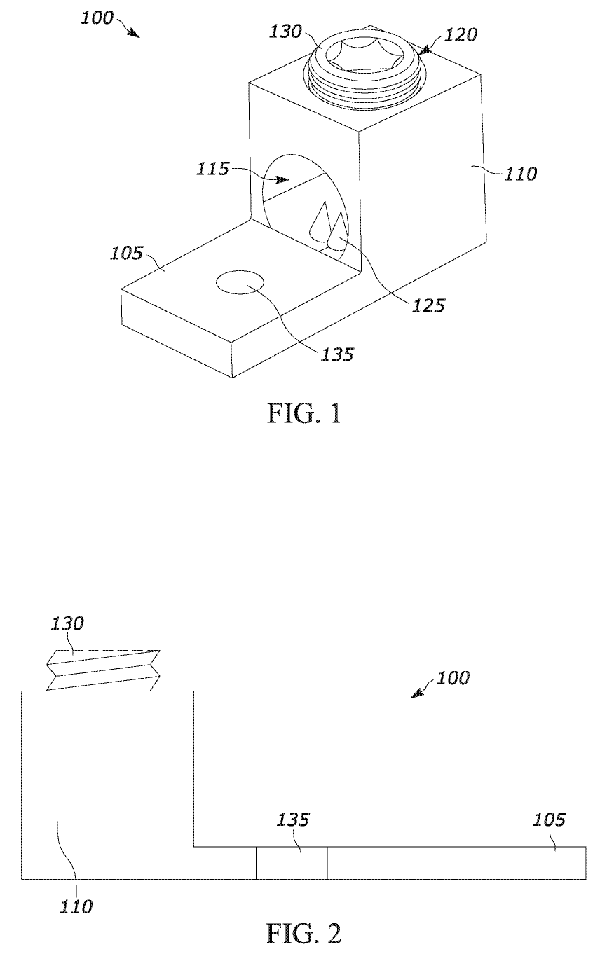

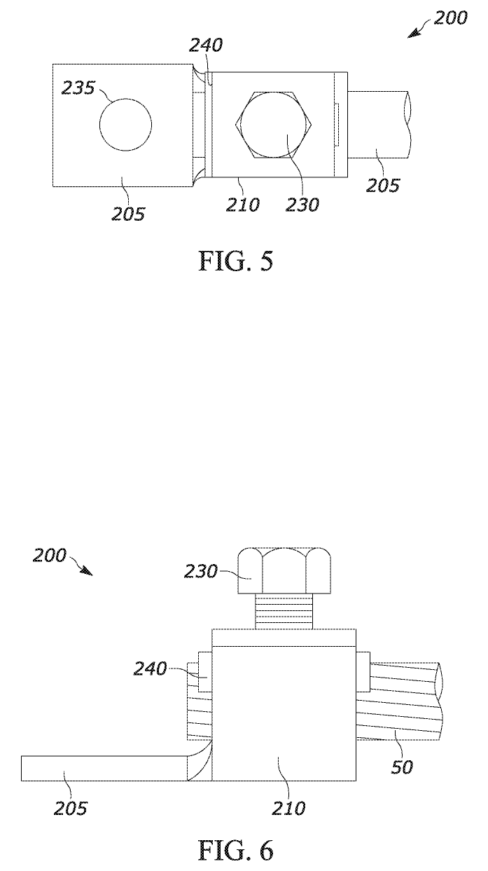

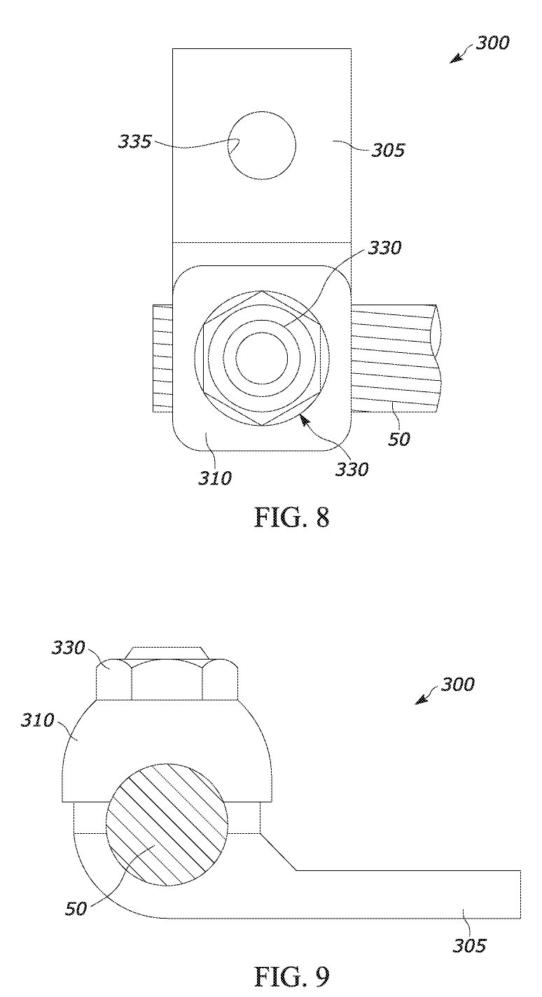

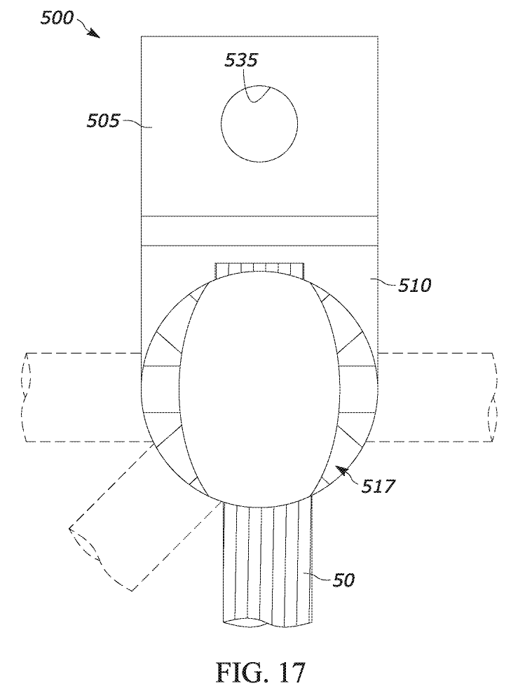

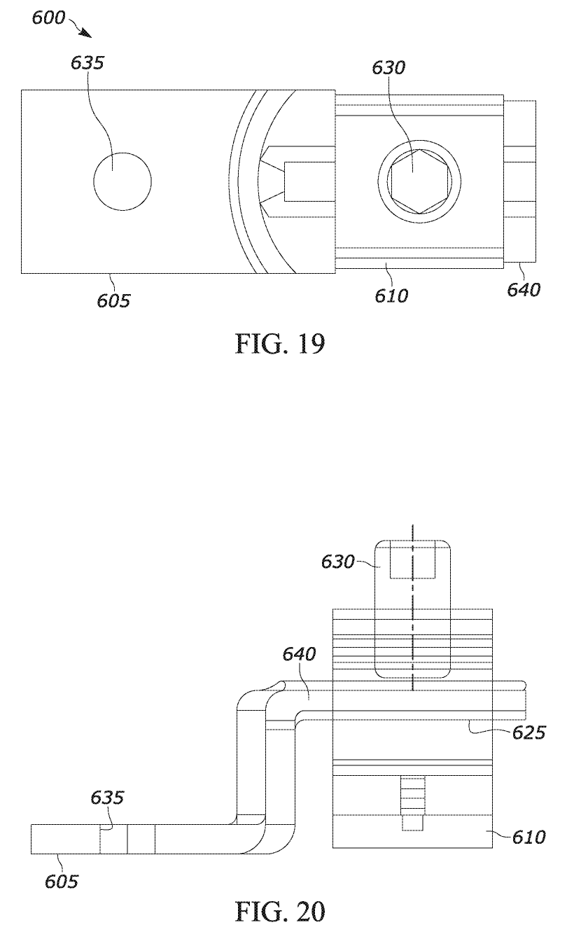

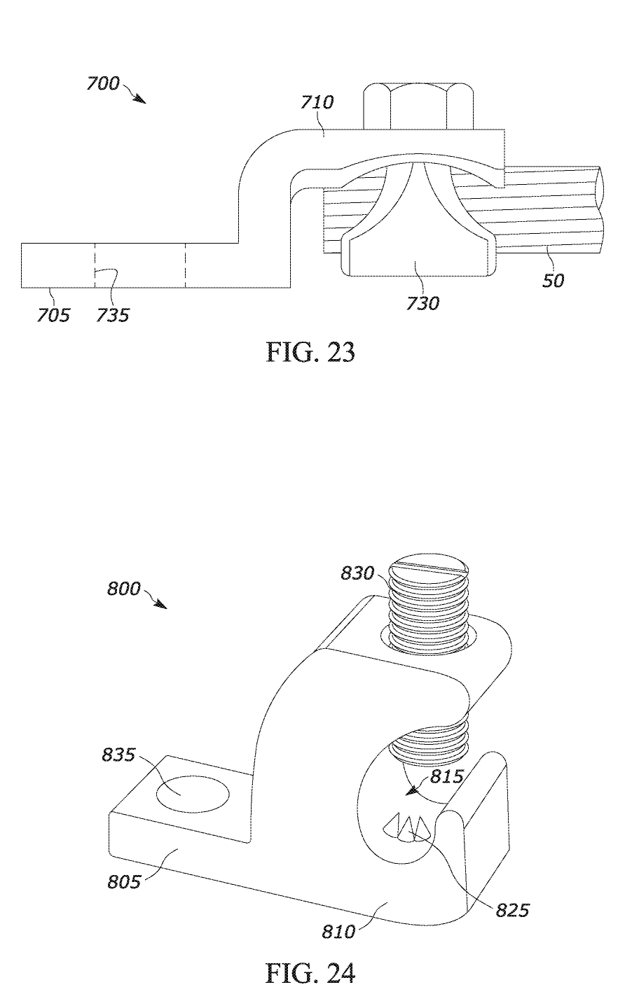

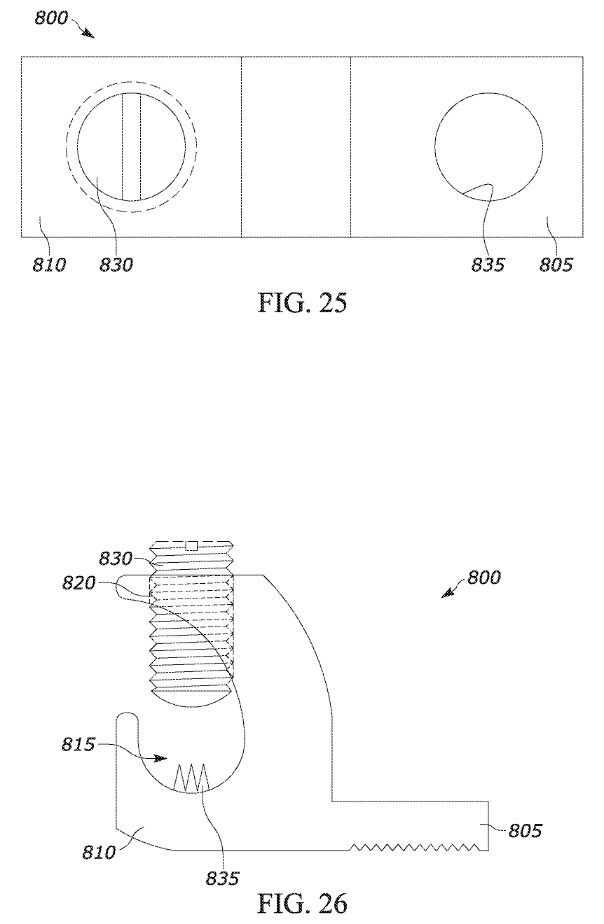

Terminal connectors disclosed in any of the examples shown in FIGS. 1-26 may be used to secure and connect electrical connectors in an electrical system. Each terminal connector may be at least partially constructed from a metallic material (e.g., copper, aluminum, steel, etc.) to create an electrical connection with an electrical conductor.

For example, each terminal connector of FIGS. 1-26 may include an interior channel or passage that is at least partially metallic. As described in more detail below, an electrical conductor may engage with the metallic material of the passage to establish an electrical connection between the respective terminal connector and the electrical conductor.

As shown in FIGS. 1-3, a first terminal connector 100 may include a base 105 with a connector portion 110 that extends from the base 105. For example, the connector portion 110 may extend in a substantially perpendicular direction from the base 105.

In some forms, the connector portion 110 may include a first passage 115 and a second passage 120. The illustrated first and second passages 115, 120 may be oriented in substantially perpendicular directions, although other orientations may be used. Additionally, the first and second passages 115, 120 may intersect with one another.

In certain forms, the first passage 115 may have a substantially circular opening that is approximately the diameter of an electrical connector. In other forms (not shown), the first passage 115 may have an opening shaped like two separate circles (e.g., with different diameters) to accommodate multiple electrical conductors of different sizes.

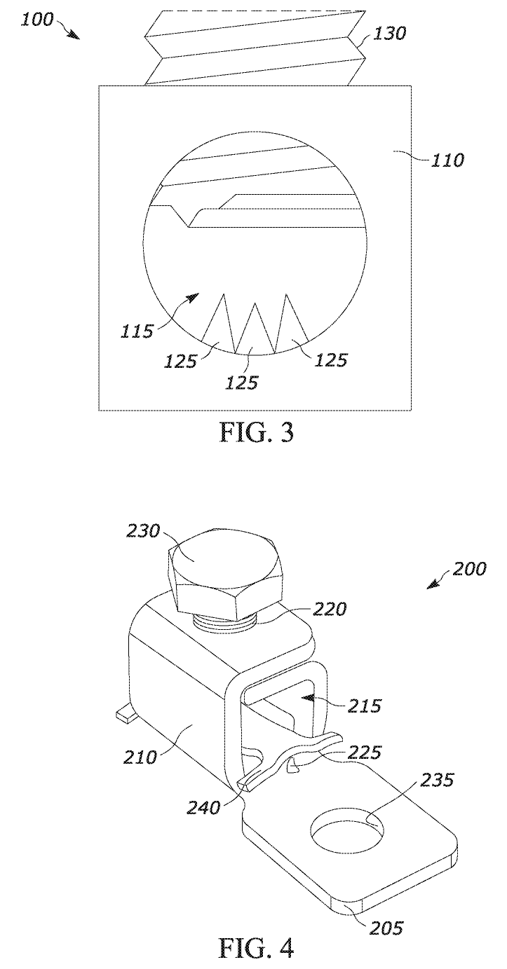

As shown in FIG. 3, the first passage 115 may include one or more teeth 125 (e.g., three shown). The teeth 125 may be clustered together and may extend from a lower end of the first passage 115 toward an upper end of the first passage 115. For example, the teeth 125 may extend toward the opening to the second passage 120. The teeth 125 may be formed from an electrically conductive material.

In some forms, the teeth 125 may extend along a length of the first passage 115. For example, the teeth 125 may extend substantially along the entirety of the first passage 115. However, other examples may include teeth 125 that are positioned only at one or both entrances to the first passage 115.

As shown in FIGS. 2 and 3, a shear bolt 130 may be disposed in the second passage 120. As will be understood by a person of ordinary skill in the art, a shear bolt 130 may be tightened and will shear at a predetermined torque.

In use, an electrical conductor may be positioned within the first passage 115. Specifically, a terminal end of the electrical conductor may be positioned within the first passage 115. The terminal end of the electrical conductor may not be connected directly to another electrical conductor but can be electrically connected to the electrical system via the terminal connector 100.

A technician may not need to strip the electrical conductor or otherwise remove an external insulative material from the electrical conductor before inserting the electrical conductor into the first passage 115. Instead, the teeth 125 may pierce the insulative covering of the electrical conductor to expose the conductive portion.

The technician may tighten the shear bolt 130 once the electrical conductor is disposed within the first passage 115. As the shear bolt 130 is tightened, it may compress the electrical conductor into the teeth 125, thereby establishing a fixed electrical connection. In other words, the shear bolt may force the electrical conductor into the teeth 125 so that the exposed portion of the electrical conductor is in contact with the teeth 125.

In certain forms, the base 105 may include an aperture 135 that can receive a fastener (e.g., a threaded fastener – not shown). The fastener may be used to secure the terminal connector 100 in a desired position.

FIGS. 4-6 illustrate a second example of a terminal connector 200, which may be similar to the first terminal connector 100. Only some similarities and differences may be described below. Similar features include similar reference numbers plus “100”.

As shown in FIGS. 4-6, a second terminal connector 200 may include a base 205 with a connector portion 210 that extends from the base 205. For example, the connector portion 210 may extend in a substantially perpendicular direction from the base 205.

In some forms, the connector portion 210 may include a first passage 215 and a second passage 220. The illustrated first and second passages 215, 220 may be oriented in substantially perpendicular directions, although other orientations may be used. Additionally, the first and second passages 215, 220 may intersect with one another.

In certain forms, the first passage 215 may have a substantially rectangular opening that is approximately the diameter of an electrical connector. In other forms (not shown), the first passage 215 may have an opening may have a different shape (e.g., circular).

As shown in FIG. 4, the first passage 215 may include one or more teeth 225 (e.g., three shown). The teeth 225 may be clustered together and may extend from a lower end of the first passage 215 toward an upper end of the first passage 215. For example, the teeth 225 may extend toward the opening to the second passage 220. The teeth 225 may be formed from an electrically conductive material.

In some forms, the teeth 225 may extend along a length of the first passage 215. For example, the teeth 225 may extend substantially along the entirety of the first passage 215. However, other examples may include teeth 225 that are positioned only at one or both entrances to the first passage 215.

With continued reference to FIG. 4, a tongue 240 may be disposed within the first passage 215. The tongue 240 may be movable in a superior-inferior direction within the first passage 215. For example, the tongue 240 may be moved in the superior direction to provide a space for an electrical conductor to be received.

In use, an electrical conductor 50 may be positioned within the first passage 215. Specifically, a terminal end of the electrical conductor 50 may be positioned within the first passage 215. The terminal end of the electrical conductor 50 may not be connected directly to another electrical conductor 50 but can be electrically connected to the electrical system via the terminal connector 200.

A technician may not need to strip the electrical conductor 50 or otherwise remove an external insulative material from the electrical conductor before inserting the electrical conductor 50 into the first passage 215. Instead, the teeth 225 may pierce the insulative covering of the electrical conductor 50 to expose the conductive portion.

The technician may tighten a bolt 230 that extends through the second passage 220 once the electrical conductor 50 is disposed within the first passage 215. As the bolt 230 is tightened, it may compress the electrical conductor 50 into the teeth 225, thereby establishing a fixed electrical connection. In other words, the bolt 230 may force the electrical conductor 50 into the teeth 225 so that the exposed portion of the electrical conductor 50 is in contact with the teeth 225.

In certain forms, the bolt 230 may extend through the tongue 240. As the bolt 230 is tightened, the tongue 240 may apply a compressive force across the length of the electrical conductor 50 within the first passage 215. In other words, the tongue 240 may help to evenly distribute the compressive force applied by the bolt 230. This may assist to ensure that the electrical conductor 50 engages the teeth 225 along the length of the first passage 215.

In certain forms, the base 205 may include an aperture 235 that can receive a fastener (e.g., a threaded fastener – not shown). The fastener may be used to secure the terminal connector 200 in a desired position.

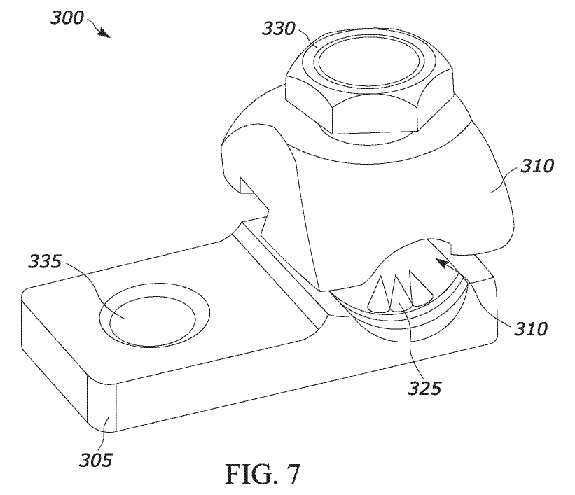

FIGS. 7-11 illustrate a third example of a terminal connector 300, which may be similar to the first terminal connector 100. Only some similarities and differences may be described below. Similar features include similar reference numbers plus “200”.

As shown in FIGS. 7-11, a third terminal connector 300 may include a base 305 with a connector portion 310 that extends from the base 305. For example, the connector portion 310 may extend in a substantially perpendicular direction from the base 305.

In some forms, the connector portion 310 may include a first passage 315 and a second passage 320. The illustrated first and second passages 315, 320 may be oriented in substantially perpendicular directions, although other orientations may be used. Additionally, the first and second passages 315, 320 may intersect with one another. The first passage 315 of the third terminal connector 300 may also be oriented substantially perpendicular with respect to the base 305, and thus perpendicular to the direction of the first passage 115 of the first terminal connector 100. The third terminal connector 300 may therefore be a right-angle connector and receive electrical conductor 50 in a substantially perpendicular direction as compared to the first terminal connector 100.

As shown in FIG. 7, the first passage 315 may include one or more teeth 325 (e.g., three shown). The teeth 325 may be clustered together and may extend from a lower end of the first passage 315 toward an upper end of the first passage 315. For example, the teeth 325 may extend toward the opening to the second passage 320. The teeth 325 may be formed from an electrically conductive material.

In some forms, the teeth 325 may extend along a length of the first passage 315. For example, the teeth 325 may extend substantially along the entirety of the first passage 315. However, other examples may include teeth 325 that are positioned only at one or both entrances to the first passage 315.

In use, an electrical conductor 50 may be positioned within the first passage 315. Specifically, a terminal end of the electrical conductor 50 may be positioned within the first passage 315. The terminal end of the electrical conductor 50 may not be connected directly to another electrical conductor 50 but can be electrically connected to the electrical system via the terminal connector 300.

A technician may not need to strip the electrical conductor 50 or otherwise remove an external insulative material from the electrical conductor before inserting the electrical conductor 50 into the first passage 315. Instead, the teeth 325 may pierce the insulative covering of the electrical conductor 50 to expose the conductive portion.

The technician may tighten the bolt 330 once the electrical conductor 50 is disposed within the first passage 315. As the bolt 330 is tightened, it may compress the electrical conductor into the teeth 325, thereby establishing a fixed electrical connection. In other words, the shear bolt may force the electrical conductor 50 into the teeth 325 so that the exposed portion of the electrical conductor 50 is in contact with the teeth 325.

In certain forms, the base 305 may include an aperture 335 that can receive a fastener (e.g., a threaded fastener – not shown). The fastener 330 may be used to secure the terminal connector 300 in a desired position.

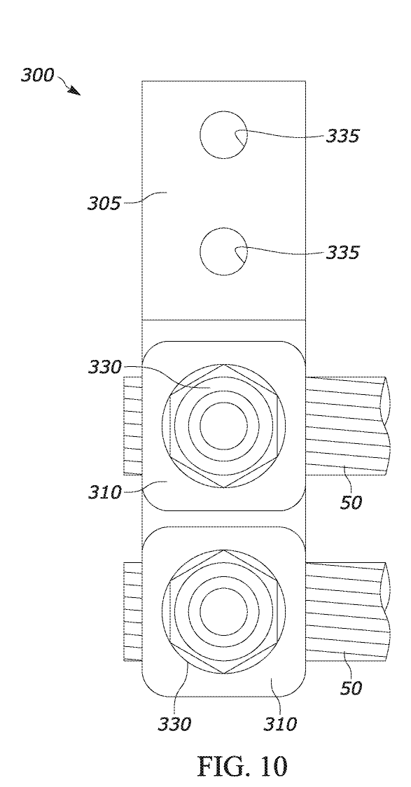

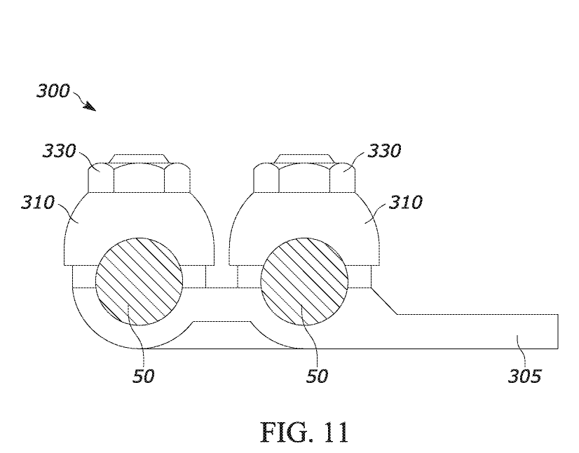

FIGS. 10 and 11 illustrate an alternate example of the third terminal connector 300, which may include a pair of connector portions 310 that extend from an elongated base 305. The connector portions 310 may be disposed adjacent to one another and may have the same features as described above. In particular, the illustrated connector portions 310 may be oriented in the same direction so that the electrical connectors 50 extend from the terminal connector 300 in a parallel alignment.

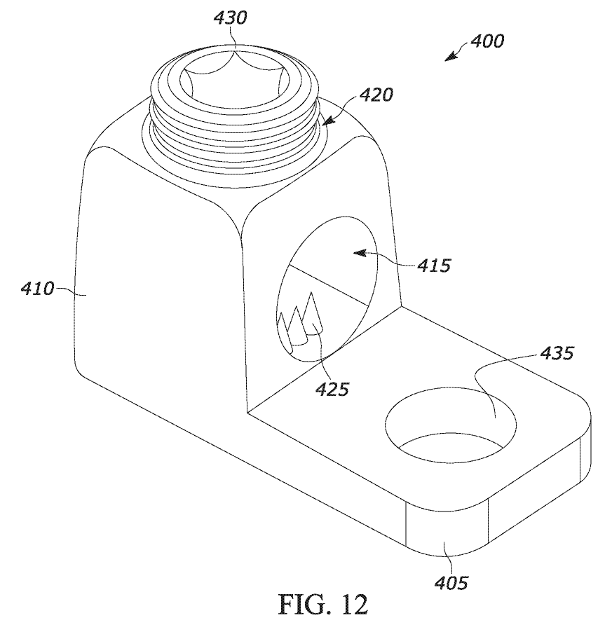

FIGS. 12-14 illustrate a fourth example of a terminal connector 400, which may be similar to the first terminal connector 100. Only some similarities and differences may be described below. Similar features include similar reference numbers plus “300”.

As shown in FIGS. 12-14, a first terminal connector 400 may include a base 405 with a connector portion 410 that extends from the base 405. For example, the connector portion 410 may extend in a substantially perpendicular direction from the base 405.

In some forms, the connector portion 410 may include a first passage 415 and a second passage 420. The illustrated first and second passages 415, 420 may be oriented in substantially perpendicular directions, although other orientations may be used. Additionally, the first and second passages 415, 420 may intersect with one another.

In certain forms, the first passage 415 may have a substantially circular opening that is approximately the diameter of an electrical connector. In other forms (not shown), the first passage 415 may have an opening shaped like two separate circles (e.g., with different diameters) to accommodate multiple electrical conductors of different sizes.

As shown in FIG. 12, the first passage 415 may include one or more teeth 425 (e.g., three shown). The teeth 425 may be clustered together and may extend from a lower end of the first passage 415 toward an upper end of the first passage 415. For example, the teeth 425 may extend toward the opening to the second passage 420. The teeth 425 may be formed from an electrically conductive material.

In some forms, the teeth 425 may extend along a length of the first passage 415. For example, the teeth 425 may extend substantially along the entirety of the first passage 415. However, other examples may include teeth 425 that are positioned only at one or both entrances to the first passage 415.

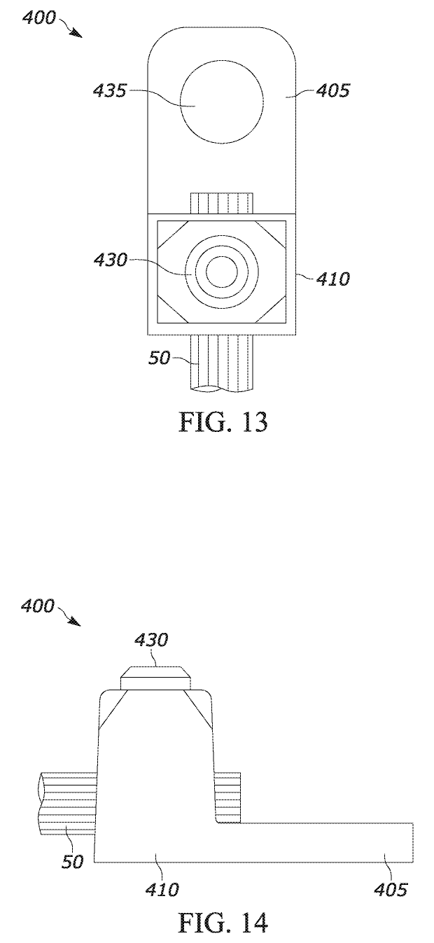

As shown in FIGS. 13 and 14, a shear bolt 430 may be disposed in the second passage 420. As will be understood by a person of ordinary skill in the art, a shear bolt 430 may be tightened and will shear at a predetermined torque.

In use, an electrical conductor may be positioned within the first passage 415. Specifically, a terminal end of the electrical conductor may be positioned within the first passage 415. The terminal end of the electrical conductor may not be connected directly to another electrical conductor but can be electrically connected to the electrical system via the terminal connector 400.

A technician may not need to strip the electrical conductor or otherwise remove an external insulative material from the electrical conductor before inserting the electrical conductor into the first passage 415. Instead, the teeth 425 may pierce the insulative covering of the electrical conductor to expose the conductive portion.

The technician may tighten the shear bolt 430 once the electrical conductor is disposed within the first passage 415. As the shear bolt 430 is tightened, it may compress the electrical conductor into the teeth 425, thereby establishing a fixed electrical connection. In other words, the shear bolt may force the electrical conductor into the teeth 425 so that the exposed portion of the electrical conductor is in contact with the teeth 425.

In certain forms, the base 405 may include an aperture 435 that can receive a fastener (e.g., a threaded fastener – not shown). The fastener may be used to secure the terminal connector 400 in a desired position.

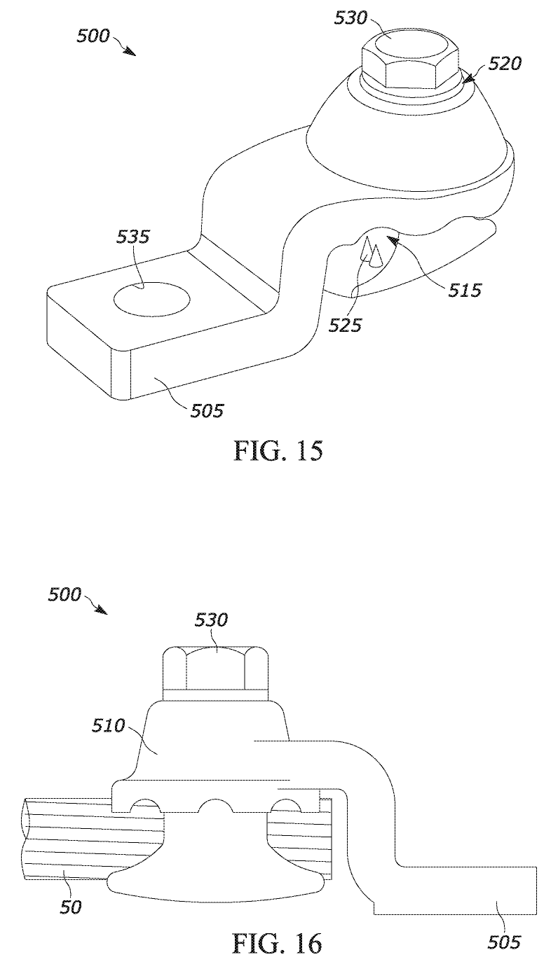

FIGS. 15-17 illustrate a fifth example of a terminal connector 500, which may be similar to the first terminal connector 100. Only some similarities and differences may be described below. Similar features include similar reference numbers plus “400”.

As shown in FIGS. 15-17, a fifth terminal connector 500 may include a base 505 with a connector portion 510 that extends from the base 505. For example, the connector portion 510 may extend in a substantially perpendicular direction from the base 505

In some forms, the connector portion 510 may include a first passage 515 and a second passage 520. The illustrated first and second passages 515, 520 may be oriented in substantially perpendicular directions, although other orientations may be used. Additionally, the first and second passages 515, 520 may intersect with one another.

In certain forms, the connector portion 510 may further include a third passage 517 that intersects the first passage 515. For example, the third passage 517 may be oriented substantially obliquely with respect to the first passage, although the third passage 517 may be oriented at any orientation. The first and third passages 515, 517 may both be perpendicular to the second passage 520.

As shown in FIG. 15, the first passage 515 may include one or more teeth 525 (e.g., three shown). The teeth 525 may be clustered together and may extend from a lower end of the first and/or third passage 515, 517 toward an upper end of the first and/or third passage 515, 517. For example, the teeth 525 may extend toward the opening to the second passage 520. The teeth 525 may be formed from an electrically conductive material.

In some forms, the teeth 525 may extend along a length of the first passage 515 and/or the third passage 517. For example, the teeth 525 may extend substantially along the entirety of the first passage 515. However, other examples may include teeth 525 that are positioned only at one or both entrances to the first passage 515.

In use, an electrical conductor 50 may be positioned within the first passage 515 or the third passage 517. Specifically, a terminal end of the electrical conductor may be positioned within the first passage 515 and/or the third passage 517. The terminal end of the electrical conductor 50 may not be connected directly to another electrical conductor 50 but can be electrically connected to the electrical system via the terminal connector 500. The electrical conductor 50 may be received in either the first or third passage 515, 517 depending on where the terminal connector 500 is used.

A technician may not need to strip the electrical conductor or otherwise remove an external insulative material from the electrical conductor before inserting the electrical conductor into the first passage 515 or the third passage 517. Instead, the teeth 525 may pierce the insulative covering of the electrical conductor to expose the conductive portion.

The technician may tighten the bolt 530 once the electrical conductor is disposed within the first passage 515 or the third passage 517. As the bolt 530 is tightened, it may compress the electrical conductor into the teeth 525, thereby establishing a fixed electrical connection. In other words, the shear bolt may force the electrical conductor into the teeth 525 so that the exposed portion of the electrical conductor is in contact with the teeth 525.

In certain forms, the base 505 may include an aperture 535 that can receive a fastener (e.g., a threaded fastener – not shown). The fastener may be used to secure the terminal connector 500 in a desired position.

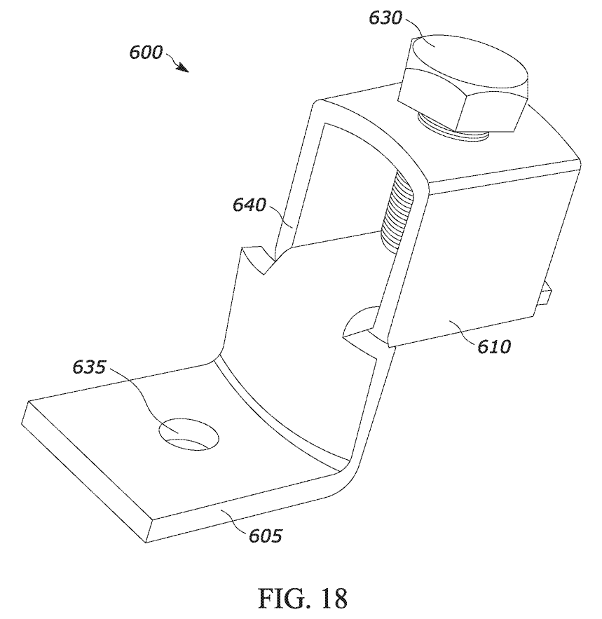

FIGS. 18-20 illustrate a sixth example of a terminal connector 600, which may be similar to the second terminal connector 200. Only some similarities and differences may be described below. Similar features include similar reference numbers plus “400”.

As shown in FIGS. 18-20, a sixth terminal connector 600 may include a base 605 with a connector portion 610 that extends from the base 605. For example, the connector portion 610 may extend in a substantially perpendicular direction from the base 605. In some forms, the base 605 may include a bend so that the connector portion 610 and at least a portion of the base 605 are formed on a different plane.

In some forms, the connector portion 610 may include a first passage 615 and a second passage 620. The illustrated first and second passages 615, 620 may be oriented in substantially perpendicular directions, although other orientations may be used. Additionally, the first and second passages 615, 620 may intersect with one another.

In certain forms, the first passage 615 may have a substantially rectangular opening that is approximately the diameter of an electrical connector. In other forms (not shown), the first passage 615 may have an opening may have a different shape (e.g., circular).

As shown in FIG. 20, the first passage 615 may include one or more teeth 625. The teeth 625 may be clustered together and may extend from a lower end of the first passage 615 toward an upper end of the first passage 615. For example, the teeth 625 may extend toward the opening to the second passage 620. The teeth 625 may be formed from an electrically conductive material. In some forms, the teeth 625 may extend along a length of the first passage 615 (e.g., the teeth 625 may extend substantially along the entirety of the first passage 615).

With continued reference to FIGS. 18-20, a tongue 640 may be disposed within the first passage 615. The tongue 640 may be movable in a superior-inferior direction within the first passage 615. For example, the tongue 640 may be moved in the superior direction to provide a space for an electrical conductor to be received. In the illustrated example, the tongue 640 may be integrally formed with the base 605.

In use, an electrical conductor 50 may be positioned within the first passage 615. Specifically, a terminal end of the electrical conductor 50 may be positioned within the first passage 615. The terminal end of the electrical conductor 50 may not be connected directly to another electrical conductor 50 but can be electrically connected to the electrical system via the terminal connector 600.

A technician may not need to strip the electrical conductor 50 or otherwise remove an external insulative material from the electrical conductor before inserting the electrical conductor 50 into the first passage 615. Instead, the teeth 625 may pierce the insulative covering of the electrical conductor 50 to expose the conductive portion.

The technician may tighten a bolt 630 that extends through the second passage 620 once the electrical conductor 50 is disposed within the first passage 615. As the bolt 630 is tightened, it may compress the electrical conductor 50 into the teeth 625, thereby establishing a fixed electrical connection. In other words, the bolt 630 may force the electrical conductor 50 into the teeth 625 so that the exposed portion of the electrical conductor 50 is in contact with the teeth 625.

In certain forms, the bolt 630 may extend through the tongue 640. As the bolt 630 is tightened, the tongue 640 may apply a compressive force across the length of the electrical conductor 50 within the first passage 615. In other words, the tongue 640 may help to evenly distribute the compressive force applied by the bolt 630. This may assist to ensure that the electrical conductor 50 engages the teeth 625 along the length of the first passage 615.

In certain forms, the base 605 may include an aperture 635 that can receive a fastener (e.g., a threaded fastener – not shown). The fastener may be used to secure the terminal connector 600 in a desired position.

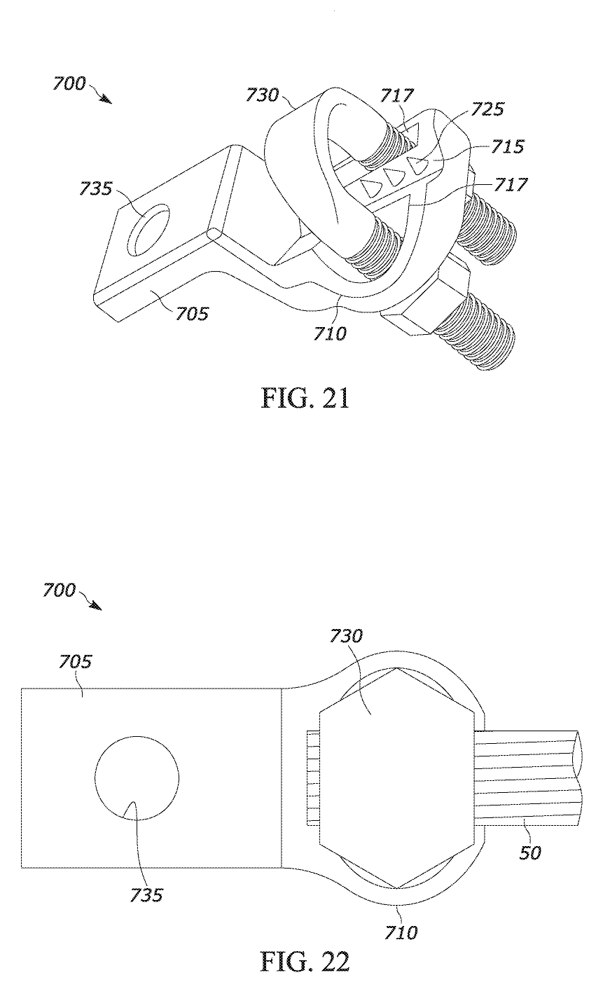

FIGS. 21-23 illustrate a seventh example of a terminal connector 700, which may be similar to the first terminal connector 100. Only some similarities and differences may be described below. Similar features include similar reference numbers plus “600”.

As shown in FIGS. 21-23, a seventh terminal connector 700 may include a base 705 with a connector portion 710 that extends from the base 705. For example, the connector portion 710 may extend in a substantially perpendicular direction from the base 705. In some forms, the base 705 and the connector portion 710 may be on different planes. For example, a substantially right-angle bend may be disposed between the base 705 and the connector portion 710.

In some forms, the connector portion 710 may include a groove 715 that extends at least partially along the connector portion 710. The groove 715 may be formed as a substantially concave region, which may be sized and shaped to receive a conductor 50. The connector portion 710 may also include a pair of apertures 717 disposed radially outside of the groove 715. The apertures 717 may extend entirely through the connector portion 710.

As shown in FIG. 21, the groove 715 may include one or more teeth 725 that may be formed from an electrically conductive material. The teeth 725 may extend along a length of the groove 715. For example, the teeth 725 may extend substantially along the entirety of the groove 715. However, other examples may include teeth 715 that are positioned only at one or both entrances to the groove 715.

A U-shaped fastener 730 may be selectively positioned around the groove 715 and through the pair of apertures 717. As described in more detail below, the fastener 730 may be tightened around the groove 725 to retain a conductor 50 within the groove 715.

In use, an electrical conductor 50 may be positioned within the groove 715. Specifically, a terminal end of the electrical conductor 50 may be positioned within the groove 715. The terminal end of the electrical conductor 50 may not be connected directly to another electrical conductor 50 but can be electrically connected to the electrical system via the terminal connector 700.

A technician may not need to strip the electrical conductor 50 or otherwise remove an external insulative material from the electrical conductor 50 before inserting the electrical conductor into the groove 715. Instead, the teeth 725 may pierce the insulative covering of the electrical conductor 50 to expose the conductive portion.

The technician may tighten the U-shaped bolt 730 once the electrical conductor 50 is disposed within the groove 715. As the U-shaped bolt 730 is tightened, it may compress the electrical conductor into the teeth 725, thereby establishing a fixed electrical connection. In other words, the bolt 730 may force the electrical conductor into the teeth 725 so that the exposed portion of the electrical conductor is in contact with the teeth 725.

In certain forms, the base 705 may include an aperture 735 that can receive a fastener (e.g., a threaded fastener – not shown). The fastener may be used to secure the terminal connector 700 in a desired position. The bend between the base 705 and the connector portion 710 may permit the base 705 to be fastened on one surface and receive an electrical conductor 50 that extends from a different plane.

FIGS. 24-26 illustrate an eighth example of a terminal connector 800, which may be similar to the first terminal connector 100. Only some similarities and differences may be described below. Similar features include similar reference numbers plus “700”.

As shown in FIGS. 24-26, an eighth terminal connector 800 may include a base 805 with a connector portion 810 that extends from the base 805. For example, the connector portion 810 may extend in a substantially perpendicular direction from the base 805.

In some forms, the connector portion 810 may include a first passage 815 and a second passage 820. The illustrated first and second passages 815, 820 may be oriented in substantially perpendicular directions, although other orientations may be used. Additionally, the first and second passages 815, 820 may intersect with one another. In some forms, the first passage 815 may be oriented in a direction that is substantially perpendicular with respect to the base 805.

In some forms, the connector portion 810 may include a first passage 815 and a second passage 820. The illustrated first and second passages 815, 820 may be oriented in substantially perpendicular directions, although other orientations may be used. Additionally, the first and second passages 815, 820 may intersect with one another.

In some forms, the teeth 825 may extend along a length of the first passage 815. For example, the teeth 825 may extend substantially along the entirety of the first passage 815. However, other examples may include teeth 825 that are positioned only at one or both entrances to the first passage 815.

As shown in FIGS. 24 and 26, a shear bolt 830 may be disposed in the second passage 820. As will be understood by a person of ordinary skill in the art, a shear bolt 830 may be tightened and will shear at a predetermined torque.

In use, an electrical conductor 50 may be positioned within the first passage 815. Specifically, a terminal end of the electrical conductor 50 may be positioned within the first passage 815. The first passage 815 may not be fully enclosed, which may permit the technician to quickly insert a conductor 50. The terminal end of the electrical conductor 50 may not be connected directly to another electrical conductor 50 but can be electrically connected to the electrical system via the terminal connector 800.

A technician may not need to strip the electrical conductor 50 or otherwise remove an external insulative material from the electrical conductor 50 before inserting the electrical conductor 50 into the first passage 815. Instead, the teeth 825 may pierce the insulative covering of the electrical conductor 50 to expose the conductive portion.

The technician may tighten the shear bolt 830 once the electrical conductor is disposed within the first passage 815. As the shear bolt 830 is tightened, it may compress the electrical conductor into the teeth 825, thereby establishing a fixed electrical connection. In other words, the shear bolt may force the electrical conductor into the teeth 825 so that the exposed portion of the electrical conductor is in contact with the teeth 825.

In certain forms, the base 805 may include an aperture 835 that can receive a fastener (e.g., a threaded fastener – not shown). The fastener may be used to secure the terminal connector 800 in a desired position.

In any of the above-described examples, the respective terminal connector may be formed as a multi-piece connector. More specifically, the teeth each respective terminal connector may be formed as a separate piece than the respective connector portion. A technician may removably connect the teeth with the respective first passage depending on the application of the terminal connector. For example, any of the terminal connectors could be used with stripped electrical connectors 50 or with insulated electrical connectors. If the insulative portion of the electrical connector 50 is already removed, the technician may opt to not connect the teeth within the first passage. However, if the electrical conductor is insulated (as described in the examples above), the technician may connect the teeth within the first passage to pierce the insulation.

In some forms, the dies or inserts may be used with any of the terminal connectors. Multiple inserts may be used with a single terminal connector. For example, one insert may include one or more teeth and another insert could include another feature (or could be substantially smooth). The technician could interchange the inserts depending on the status of the electrical connector 50 (e.g., stripped or unstripped).

In other examples, the teeth may be removably connected to the surface of the first passage with one or more connectors – e.g., a mechanical connector, a magnet, an adhesive, etc. The technician may selectively insert or remove the teeth (or any other feature) from the first passage. Once removed, the insert could be reinserted and attached within the first passage.

In any of the above-described examples, the respective fastener may include a point or tooth at the end received within the second passage. In some examples, the tooth from the fastener may pierce the insulative portion of the electrical conductor.

One of ordinary skill will appreciate that the exact dimensions and materials are not critical to the disclosure and all suitable variations should be deemed to be within the scope of the disclosure if deemed suitable for carrying out the objects of the disclosure.

One of ordinary skill in the art will also readily appreciate that it is well within the ability of the ordinarily skilled artisan to modify one or more of the constituent parts for carrying out the various examples of the disclosure. Once armed with the present specification, routine experimentation is all that is needed to determine adjustments and modifications that will carry out the present disclosure.

The above examples are for illustrative purposes and are not intended to limit the scope of the disclosure or the adaptation of the features described herein. Those skilled in the art will also appreciate that various adaptations and modifications of the above-described preferred examples can be configured without departing from the scope and spirit of the disclosure. Therefore, it is to be understood that, within the scope of the appended claims, the disclosure may be practiced other than as specifically described.

What is claimed is:

1-15. (canceled)

16. A method of assembling a terminal connector for use with an electrical conductor, the method comprising:
providing a connector portion including a first passage;
selectively coupling a tooth to a surface of the first passage based on a status of the electrical conductor, wherein the tooth is formed from an electrically conductive material;
wherein, when the electrical conductor is unstripped, the tooth is coupled to the surface of the first passage to pierce an insulating portion of the electrical conductor and form an electrical connection between the connector portion and the electrical conductor; and
wherein, when the electrical conductor is stripped, the tooth is omitted from the first passage.

17. The method of claim 16, wherein selectively coupling the tooth comprises removably connecting the tooth to the surface of the first passage with at least one of a mechanical connector, a magnet, or an adhesive.

18. The method of claim 16 wherein the tooth is disposed on an insert, and wherein selectively coupling the tooth comprises inserting the insert into the first passage.

19. The method of claim 18, further comprising interchanging the insert with a second insert having a substantially smooth surface.

20. The method of claim claim 16 further comprising inserting the electrical conductor into the first passage after selectively coupling the tooth, and moving a fastener through a second passage that intersects the first passage to secure the electrical conductor within the first passage.

21. The method of claim 20, wherein the fastener includes a point at an end received within the second passage, and wherein the point pierces the insulating portion of the electrical conductor.

22. A terminal connector comprising:
a base including a bend;
a connector portion extending from the base, wherein the bend disposes the connector portion and at least a portion of the base on different planes;
the connector portion including a first passage and a second passage that intersects the first passage; and
a tooth disposed at least partially along the first passage, the tooth formed from an electrically conductive material; wherein the first passage is configured to receive an unstripped portion of an electrical conductor;
wherein the tooth is configured to pierce the unstripped portion and form an electrical connection between the connector portion and the electrical conductor; and
wherein the bend is configured to permit the base to be fastened on a first surface and receive the electrical conductor extending from a different plane than the first surface.

23. The terminal connector of claim 22, wherein the first passage has a substantially rectangular opening.

24. The terminal connector of claim 22 further comprising a tongue disposed within the first passage, wherein the tongue is movable within the first passage and is integrally formed with the base.

25. The terminal connector of claim 24, wherein a bolt extends through the second passage and through the tongue, and wherein tightening the bolt causes the tongue to apply a compressive force across a length of the electrical conductor within the first passage.

26. The terminal connector of claim claim 22 wherein the first passage is oriented in a direction substantially perpendicular with respect to the base.

27. The terminal connector of claim claim 22 further comprising an aperture in the base configured to receive a threaded fastener to secure the terminal connector in a desired position.

28. A terminal connector comprising:
a base; a pair of connector portions extending from the base, each connector portion including a respective first passage and a respective second passage that intersects the respective first passage; and
a respective tooth disposed at least partially along each respective first passage, each respective tooth formed from an electrically conductive material;
wherein each respective first passage is configured to receive an unstripped portion of a respective electrical conductor;
wherein each respective tooth is configured to pierce the unstripped portion of the respective electrical conductor and form an electrical connection between the respective connector portion and the respective electrical conductor.

29. The terminal connector of claim 28, wherein the pair of connector portions are disposed adjacent to one another and oriented in a same direction so that the respective electrical conductors extend from the terminal connector in a parallel alignment.

30. The terminal connector of claim 28 wherein each respective second passage is oriented in a direction substantially perpendicular to the respective first passage, and wherein a respective fastener is selectively received within each respective second passage.

31. The terminal connector of claim claim 28 wherein the base is an elongated base.

32. The terminal connector of claim claim 28 wherein each respective first passage is oriented in a direction substantially perpendicular with respect to the base.

33. The terminal connector of claim 30, wherein each respective fastener is configured to compress the respective electrical conductor into the respective tooth to establish a fixed electrical connection.

34. The terminal connector of claim claim 28 further comprising an aperture in the base configured to receive a threaded fastener to secure the terminal connector in a desired position.
